(19) United States
(12) Patent Application Publication
(10) Pub. No.: US 2007/0185994 A1
(43) Pub. Date: Aug. 9, 2007

(54) System and method for authentication permitting access control to electronic information and software applications between remotely accessed computer systems

(76) Inventor: Michael Gerard Lalonde, Alpharetta, GA (US)

Correspondence Address: MICHAEL G. LALONDE, 715 NEWPORT HOLLOW, ALPHARETTA, GA, 30005, US

(21) Appl. No.: 11/375,764

(22) Filed: Mar. 14, 2006

Related U.S. Application Data
(60) Provisional application No. 60/661,375, filed on Mar. 14, 2005.

(51) Int. Cl. G06F 15/173

(52) U.S. Cl. 709/225

(57) ABSTRACT

A system and method for information security, more particularly relating to the intervention of an access requesting computer or ARC, by a permission processing access controller or PPAC, whereby the access requesting computer is desirous of accessing electronic information or software applications or digital token through electronic networks in which said permission processing access controller controls access to said electronic information and software applications through authentication and access control means. The authentication and access control means are provisioned with certain identifying attributes of the ARC and environmental information external to the ARC which is acquired through imposed discovery by the PPAC pertaining to the access requesting computer, corresponding identifying network and environmental information attributes which information in totality is collectively processed through computational means utilizing a decision based algorithm and permission logic to permit access to said access protected information and software applications within predefined parameters.

### BACKGROUND OF THE INVENTION

1. Field of the Invention

The present invention relates to electronic information security between remotely accessed computer systems, more particularly relating to session authentication with access control utilized to permit access to protected electronic information which includes: information; software applications; digital tokens and other such electronic information which computer systems require access and other such methods which would intervene and control permission to access protected information which may not be electronic by employing a method of authentication exemplified by one example, but not limited to this only example: a human face-to-face interaction whereby one or more persons desirous of receiving protected information presents certain identifying information needed to authenticate in person, and the person or entity protecting information uses certain identifying information from said person desirous of accessing protected information and, performs authentication based on this certain identifying information.

2. Description of Prior Art

Computer systems and networks of computer systems are pervasive in all aspects of life and business and are vital to many critical functions which impact human preservation and economics. These computer systems and related computer networks are well known in prior art. Computer systems guided by human interface, hereafter known as the term “users”, most commonly access information and software applications through local area networks (LAN), wide area networks (WAN), public open networks such as the Internet and other types of networks, to mention only a few examples of said networks, heretofore known as “networks”. Commonly, fully or semi-automated discrete operating computer systems which are not reliant on users to operate, are used to access other computers systems or users, in this context, the term “computer(s)” shall mean, but is not limited to, computer systems operated by users or discrete operating computers including particular subsystems or other portions of the computer system among other similar types. Prior art also teaches other manner of interaction between computers and users of said computers such as messaging, the means in which one user contacts another or through a user's computer or, to another computer, which includes among other methods: email; instant messaging and, accessing certain software applications; accessing information documents and portions of documents and, not limited to accessing other types of data and objects among others many other types of means to access and exchange of information. For the purpose of this specification, the term “exchange information” shall be used to mean all of the aforementioned means of accessing and exchanging information, software applications, and others. Information that is protected or accessed by users and other computers operated or not operated by users such as discreet computers, sometimes using means of authentication, that may employ access control methods or similar methods to control access to information, which information is commonly includes but is not limited to: data; documents; software applications; information regarding the status or identification of other computer and devices of computer networks; identifying information pertaining to users to be authenticated including shared secret information and generally known information and, other such types information which has not been mentioned herewith which may be valuable and or, may be deemed to be necessary for any reason or reasons to protect from users or entities desirous of accessing such information heretofore known collectively as “protected information”.

At the time of this writing, to contemplate the means by which computers or users of computers gain access to information and exchange information from and among other computers, it is known to those skilled in the art, that various forms of identification protocols are most commonly used to control information access. Identification protocols facilitate the use of identification indicia such as usernames to identify a computer user and password(s) secret to said user and known to the authenticating computer to protect the information from unauthorized access, use and modification among others. The term “identification indicia conjunction”, heretofore known as IIC, shall refer to user(s) name and or password(s) and other common types of identification indicia facilitated by the identification protocol. Widely disclosed prior art relating to identification protocols illustrates pre-described methods and computer languages to acquire and authenticate the IIC commonly concluding in a disposition on the request to access information by computers, and in some cases, access requests of these same computers by users and operator which is one in the same, that is to say, rather than remote computers requesting authentication by one or another, a user's computer may itself require the user to be authenticate to access protected information. It is therefore of great interest to the person's skilled in the art that increasingly more intuitive means to determine the truthfulness in authenticating access to protected information is continually sought and considered to be very valuable with regard to the predisposition of said protected information in particular, the continuously greater importance of said protected information and the increasingly greater amount of said protected information as the reliance of computers and interconnecting means.

Why Computer Network Security is Needed

The protection of computer networks and computers is a high priority with, organizations and individuals hereafter collectively known as “entities”, who have vital interests in protecting valuable information which can be accessed, used and modified by other computers and users of said computers. Authentication between computers and users of said computers is a central problem in computer security and access control to valuable information, network intrusion detection (Kemmerer & Vigna, 2002), mobile network access (Clarke 2005), information systems (Blobel & Pharrow, 2001), e-govemment (Boudriga, 2002), and e-commerce (Soh & Joy, 2004). During the process of authentication, computers and users of computers establish legitimacy of identity by transmitting a credential set over a possibly insecure channel using an identification protocol as one method of many. The credential set includes IIC, one or more authentication factors or identification indicia, which can be regarded as secrets shared between the user and the remote system (Yoon et al., 2005). Identification indicia can be broadly categorized into four classes: informational (what you know), token-based (what you have), biometric (what you are), or behavioral (how you act). Common examples of each include but are not limited to: passwords, personal identification numbers (PINs) and challenge-response systems; keys, cards, smart cards, badges, tickets, and time-synchronized pseudorandom number generating devices; speech, facial images, fingerprints, iris scan, and palm prints; and keystroke dynamics, signature, network activity, and usage profiles (O'Gorman, 2003; Faundez-Zanov, 2005; Obaidat & Sadoub, 1997; Weatherford, 2002; Maxion & Townsend, 2004) to name only a few of many. Sometimes digital certificates and other public key infrastructure (PKI) approaches are also regarded as informational authenticators (Stuhimuller, 2000).

Traditional single factor authentication, while simplistic and prevalent, is prone to attack and repudiation: secrets such as passwords and PINs may be shared, lost or forgotten; tokens may be shared, forged, or stolen; and behavior may not be unique, or may change over time. Biometric factors, which are often preferred because of their strong non-repudiation feature (i.e., they cannot be shared or transferred), suffer from their own unique set of authentication risks, including privacy concerns, the possibility of an attacker to intercept biometric credentials, and the permanency of biometrics (Jin, Lin, & Goh, 2004; Bolle, Connell, & Ratha, 2002). So-called strong user authentication schemes seek to overcome some of these shortcomings by combining two (or more) authenticators, often from disparate factor classes, to reduce the risk of attack or non-repudiation (Schneier, 2005). A familiar example of two-factor authentication is the combination of card and PIN (token+information) required for automated teller machine (ATM) access. While generally regarded as more secure than single-factor approaches, strong user authentication is still subject to cryptographic attacks, e.g. phishing, masquerading, and Trojan horse (Maxion & Townsend, 2004; Schneier, 2005).

Constructing of computer networks and computers that resist attempts by fraudulent perpetrators and malicious attack is the persistent objective of many entities that possess a need to protect information made available through computer networks. Electronic perpetrators exploit subtle flaws and effects in computers and computer networks security mechanisms and, more typically but not limited to, exploit interactions between computers. The very nature of computers that demonstrates their usefulness, the means to automate the processing of vast amounts of information relatively instantly, also produce means for perpetrators to use these same computers in ways that automate and dramatically increase the effectiveness of fraudulent activities. At present, perpetrators are represented by reasonably small numbers in contrasts to the numbers of legitimate users negotiating access to information through networks.

This need to expand computer networks and reliance on these networks to obtain sometimes valuable and secret information and software applications has greatly increased the potential access of by fraudulent perpetrators using means which appear legitimate. The more information and increasing sensitivity and vital nature of information that is made available through the expansion of computer networks often creates considerable more complexity of the guarding same. Computer systems present themselves as digital facsimiles of one another when requesting access to other computer systems through computer networks. With most access controllers, the system which protects access to information, each computer system facsimile appears the same with generally the distinction from one computer system and another only that of the identifying indicia. This digital facsimile can be presented over and over again each time using different identifying indicia each time numerically eliminating unsatisfactory combinations. Attempts to discover the correct identifying indicia from repeated attempts beyond reasonable attempts performed by a legitimate user are often performed by fraudulent perpetrators using manual or automated processes with computer systems in an effort to gain access to vital information and or invoke malicious attack.

The Vulnerability of User Names and Passwords

A very common method and in relative terms, reasonably easy to succeed in said penetration, is to discover identification indicia or shared secrets. Identification is an assertion about a computer or the user of a computer. User names and passwords represent an assertion. Authentication refers to the process by which a system establishes that an identification assertion is valid. To increase perpetrators chances of successfully discovering appurtenant identification indicia, perpetrators commandeer the use of computers to artificially manifest virtual users and use these same virtual users in the assailing of other computers protecting access to information. Identification indicia conjunctions, in this example, user names and passwords, are commonly designed so that they can be easily remembered by users and replicated by the user during an information access request session. These conjunctions are often finite and reasonably small in letters, numbers and symbols. The universally available use of computers to test all ratiocinative possibilities of combinations of identification indicia conjunctions and to do so efficiently within practical time durations, presents significant weaknesses in the systems employed by computers which protect access to information using user names and passwords.

In FIG. 2A, a simplified example of prior art using identification protocols, user authentication sequence and authorization means controlling protected information is illustrated. In the overview 228, the access-requesting computer, hereafter known as “ARC”, requests protected information 212 from the permission possessing access control, hereafter known as “PPAC”. Both the ARC and the PPAC authenticate to each other 216, the ARC requesting credentials of the PPAC in order that the ARC is safe to transmit IIC to the PPAC, after which access to protected information 220 is granted. Following the information fulfillment requirement of the ARC, the sequence is terminated 224. Further detail of overview 228, is described in flow-chart illustration 232. In said illustration 232, the ARC initiates a sequence by requesting protected information 236 from the PPAC. Commonly known prior art, the ARC may want to authenticate the PPAC before the ARC transmits IIC. This type of procedure, in some cases, helps thwart imposters of PPAC from obtaining ARC IIC. In this specific circumstance, request for protected information from PPAC 236 causes the sequence provided in FIG. 2B to be initiated departing from point 240 on FIG. 2A. In FIG. 2B, PPAC receives initial authentication request 244 ARC. PPAC responds to ARC with identifying credentials 248 such that ARC can be reasonably assured that it can transmit IIC to the PPAC once this sequence is determined to be true. The ARC proceeds to authenticate PPAC credentials 252. If the PPAC credentials are correct by providing the answer “yes” 264, the ARC proceeds with the original task of transmitting IIC to the PPAC 268 through B 272. If the credentials are incorrect by providing the answer “no” 256 which concludes the PPAC does not satisfy authentication by the ARC, then session attempt with the PPAC is terminated 260.

Returning to FIG. 2A from FIG. 2B through B 272, in response to information request 236, the PPAC begins a corresponding sequence with a request that the ARC authenticate with a test of IIC 276. The user of the ARC or the ARC itself operating independent of the user in an automated fashion, has previously been assigned password, P which is one of many possible and well known aspects of IIC in an example of authentication protocol. The basis of password authentication relies on a one-way hash function, ƒ( ), which is not required to be a secret function, such that given p it is easy to compute y=F(p), but the converse is not true. That is, given y=F(p), it is not practical with regard to computational speed, to compute p=F⁻¹(y) To authenticate, the ARC transmits p and the PPAC computes y=F(p). The PPAC retains a table of valid y for each user, and compares the results from the ARC to those of the table. This system protects user secrets from intrusions on the PPAC, but not from eavesdropping attacks. Prior art includes many well-known extensions that accommodate remote user authentication (Lamport, 1981; Yoon, 2005).

In one scenario of two possible scenarios, if test 276 does result in a match of the IIC as indicated by the answer “no” 278, then the sequence proceeds to test 280. The sequence is then further tested 280 to determine whether a certain number of authentication attempts, >n, have been performed. In yet another scenario, one scenario of two possible scenarios, if at test 280 the number of authentication attempts is<n, then the authentication sequence will answer “no” 282 and proceed to a third test 286. In this scenario, test 286 determines whether or not password restoration has been attempted. Password restoration has relevance at test 286 since failure to restore a password indicates the authentication sequence may be fraudulent and conducting procedures to discover the IIC through numerical elimination or by testing known combinations of IIC which may apply to a certain discoverable facts known to the perpetrator about the authorized entity. Permitting unlimited attempts to test combinations of IIC would greatly enhance the ability for a perpetrator to discover the correct conjunction. In one scenario, one of two possible scenarios, if at test 286 the answer is “no” 288, then the authentication sequence proceeds to forgotten password procedure 290. One of several options that is taught in numerous examples of prior art and is commonly available in said similar forgotten password procedures is the option to forego password restoration and reattempt the authentication sequence using a new IIC. Still other options presented in a forgotten password procedures well taught in prior art examples is various methods that can be employed to restore IIC, some of which involve automated means such as transmitting new IIC to trusted known address through postal service mail or through trusted known emails addresses or other less automated means such as person-to-person contact over telephones with live representatives of the PPAC entity and not limited to many other means of restoring IIC. Further details of IIC restoration is not of significant relevance to the description of the preferred embodiment of the present invention. Proceeding from forgotten password procedure 290, the authentication sequence is reinitiated by test 276 in a second attempt and in numerous possible attempts until a failure to match the IIC is >n a test 280 is met resulting in the answer “yes” 292 or test 280 matches the IIC and results in a “yes” 274. In the second scenario of two possible scenarios whereby the IIC is matched in 276 resulting in the answer “yes” 274, the ARC request for protected information from the PPAC is granted and said protected information is accessed 296. The session sequence can then be terminated by the ARC 298 after protected information is accessed by the ARC or at any time suitable to the ARC. If in the second possible scenarios of two, test 280 results in >n attempts satisfied, the answer “yes” 292 is achieved and the authentication sequence is directed to provide authentication rejections notification 294 and thereafter terminate the sequence. Similarly, in the second possible scenario of two, password restoration test 286 results in answer “yes” 284, authentication rejection notification 294 is provided and corresponding the authentication sequence in ended. A significant drawback to entities protecting information using the method described in FIG. 2 reveals itself in that there is no way to reliably determine whether or not an ARC is repeatedly creating new authentication sessions in order to discover the correct IIC by terminated one session and initiating yet another repeatedly until said conjunction is successfully discovered.

### BRIEF SUMMARY OF THE INVENTION

The process known to the art of permitting access to protected information, in generality, requires fundamental two parts, at least two entities that are desirous of in the first part, the role of requesting access to said protected information, ARC, and in the second part the role of restricting access to protected information, PPAC, to only those entities whom have determined, predetermined and or reassigned rights to access protected information. In further generality, the ARC shares with the PPAC secret knowledge of IIC which when confirmed that such IIC is acceptable to the PPAC, access to said protected information or portions of protected information is granted. Prior art has taught that the general practiced of authentication and access control of protected information largely and generally follows the aforementioned method whether said IIC is obfuscated in encrypted means, said IIC is seeded or shared by information transmitted in a secure manner outside the computer network or, said IIC which is derived from known sources that is unique to the entity such as biometric information among other methods in similarity. Commonality to methods known to the art is the reliance on a secret which is known to both the ARC and PPAC for which there is a substantial weakness when said secret is discovered by entities that are not permitted to know such secret which are more likely to be malicious or profiteering than mistaken in nature.

A method which does not entirely rely on secret information in IIC is one of the objects of the preferred embodiment of the invention. The use of information which is not entirely reliant on a secret but rather is more expansive in relying on information which can be obtained about an entity and information which may be related to the entity during the interaction of said entity throughout the authentication process and changes in said information which may occur in the past, present and future is suggested and relied upon by the preferred embodiment to be more comprehensive and trustworthy than solely relying on secret information. Non-similar to reliance solely on secret information which has been taught by the art to have significant weakness due to the discoverability of such secret information, conversely, the reliance of obtained information presents additional factors that are substantially difficult for perpetrators to replicate in there entirety and more over, increasingly difficult for perpetrators to replicate this information in a manner which is consistent to the information gathering entity, PPAC, in particular if said entity contemplates such gathered information over one or more authentication sessions which are known and reasonably validated within reason proximity of a truth scale to be true. Such contemplation of gathered information, which when augmented by IIC is processed by computational means which in the methods which is hereafter described, permits substantially greater means to provide said computational results that indicate the truthfulness of the ARC in the authentication process in a reasonable time period which is required by the speedy response demands of performing authentication in commonly known scenarios of business and financial applications to name only two of many.

The preferred embodiment of the invention relates to a sub-operation of the greater authentication process, well-known to prior art, between ARC and PPAC. One aspect of the present invention is to compliment and work in conjunction with other authentication means such as describe and detailed in the aforementioned background section of this specification which types of other authentication means includes but is not limited to: the use of IIC; further means of obfuscating IIC with encryption; deriving IIC from secretly possessed seeds for keys; deriving IIC from separately generated seeds obfuscated from interception to thwart observation by an eavesdropper such as use of a mechanism independent from the network for which the authenticating entities have knowledge of encryption algorithms that generate codes from seeds which are placed in such mechanisms not within the network or through any computers involved in the authentication process in an attempt to obfuscate said algorithm and seeds from eavesdroppers and; IIC which is derived from biometric information or information which is based on some object that is in possession or control of the ARC entity that uses information from a related process or object and; many other variations of these methods well known from prior art which are not all represented here in their entirety.

As earlier elaborated and pertaining to prior art that utilizes means and methods to authenticate entities, the preferred embodiment of the invention provides a further means to supplement the authentication process by acquiring information which is known by either or both of the entities activity in the authentication process including but not limited to other information pertaining to entities or independent knowledge which is not actively engaged in the authentication process. A practical example and that which is used to illustrate the preferred embodiment of the present invention, elaborates on the erudition of certain identifying information and or information representing events and or some form of information that is desirous of obtaining, heretofore collectively known as “certain signifying information”, that is possessed by the ARC, additionally and similarly, the erudition of certain signifying information and or information representing events that is possessed and produced by the connecting network, the further erudition of certain signifying information that is possessed by the PPAC and, other erudition of information, certain signifying information and otherwise, that is possessed and or produced by entities and or sources that are external to any of the certain signifying information sources, information sources and methods described herewith and, the erudition of other certain signifying information which may exist, produced and or modified resulting from the interaction of one or more of any aspect these sources of certain signifying information or information.

After completing the process of gathering aforementioned certain signifying information and or information pertaining to the process of authenticating ARC for purposes of assessing whether or not the ARC is truthful in representing itself as a rightful entity permitted to access protected information which is guarded by the PPAC, the present invention facilitates and improves the ability of the PPAC in ascertaining permission status of said ARC by use of computational means that provides greater probability that the resulting permission status of the ARC is true. Said computational means use-d to ascertain the permission status of an ARC is in part influenced by the of gathering certain signifying information and other information and the processing of said information from multiple collections of information which are identified in groups, heretofore known as “signifying information groups”, for simplification of description but are not limited to said number of groups or limited to types of information contained therein any one group or limited to the means by which information is gathered.

One specific method used to described the preferred embodiment of the invention in the processes of gathering certain signifying information from signifying information groups which is well known in prior art, includes but is not limited to: sub-related information the ARC, as illustrated by one in a particular sub-related information set, computer identity information, hereafter known as “CII”; another one particular sub-related information set in ARC computer is configuration information, hereafter known as “CCI”; devices used to interconnect computers within and throughout networks which are used to route and transfer computer information, more specifically, between ARC and PPAC and other computers which are related or interrelated to each heretofore known as “network device information”; information known to the PPAC through its interrelated processes that capture and retain temporarily, semi-permanently or permanently to a given practical extent derived by the circumstances of the entity whishing to retain said information, discernable facts and events relating to ARC authentication and ARC access of protected information in present instance, past instance and future instance, of sessions, collectively referred to as and to be known hereafter as “session related information”; information that is external to the processes of both ARC and PPAC which shall include but is not limited to information, facts and events external to processes within and throughout all of the aforementioned information. Said environmental information represents facts and events which shall include such sources from: news that shall be local, regional and global; any industry indices, local, regional and global; measurable indicators of data traffic on all kinds of computer networks; financial information such as that relating to financial markets and money transfer activity, local, regional and global; government indicators and national security alters and indicators, also that of international security alters and indicators, and many other sources of external information which shall be known hereafter as “environmental information” or EI.

### BRIEF DESCRIPTION OF THE DRAWINGS

A further understanding of the present invention will become apparent upon consideration of the following detailed description, taken in connection with the accompanying drawings, wherein:

FIG. 1 is a object chart representation of the process of authentication between an ARC and PPAC embodying the present invention.

FIG. 2A is an object chart representation of the process of authentication between and ARC and a PPAC that is practiced in prior art.

FIG. 2B is a sub-operation and continuation of a part of FIG. 2A.

FIG. 3

FIG. 4

### DETAILED DESCRIPTION OF THE INVENTION

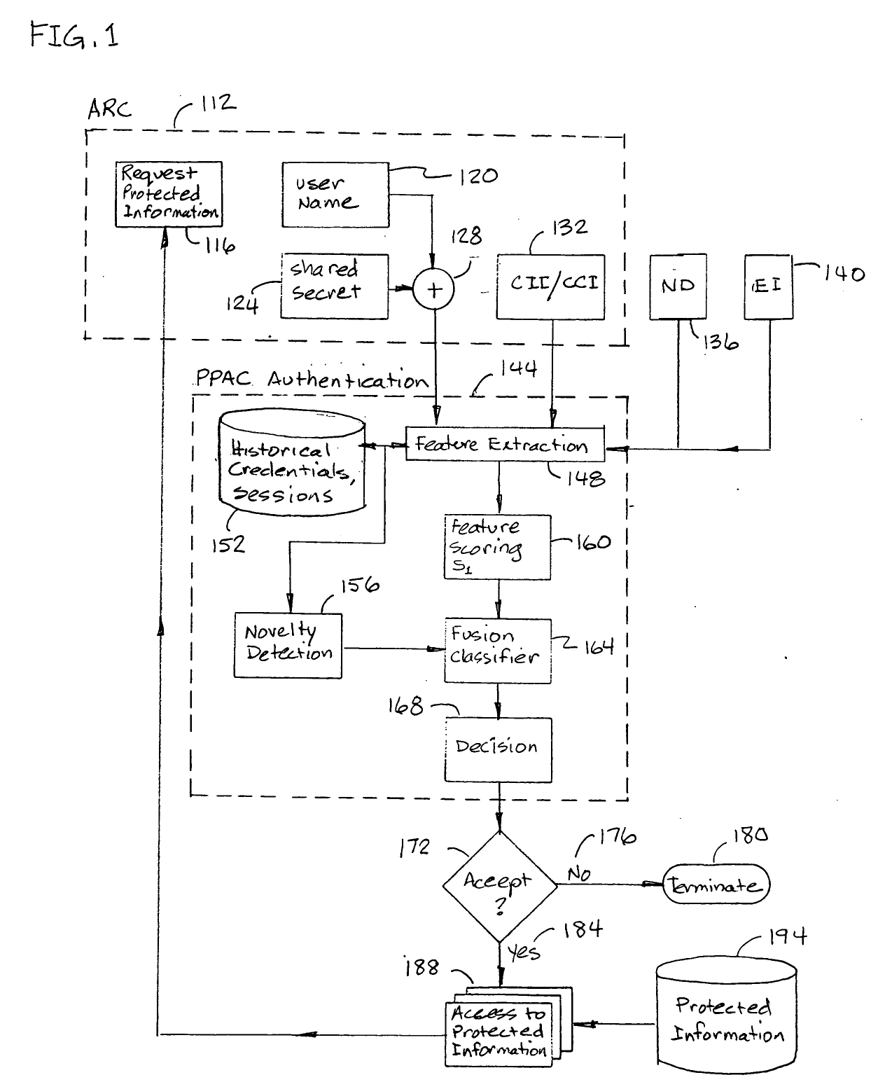

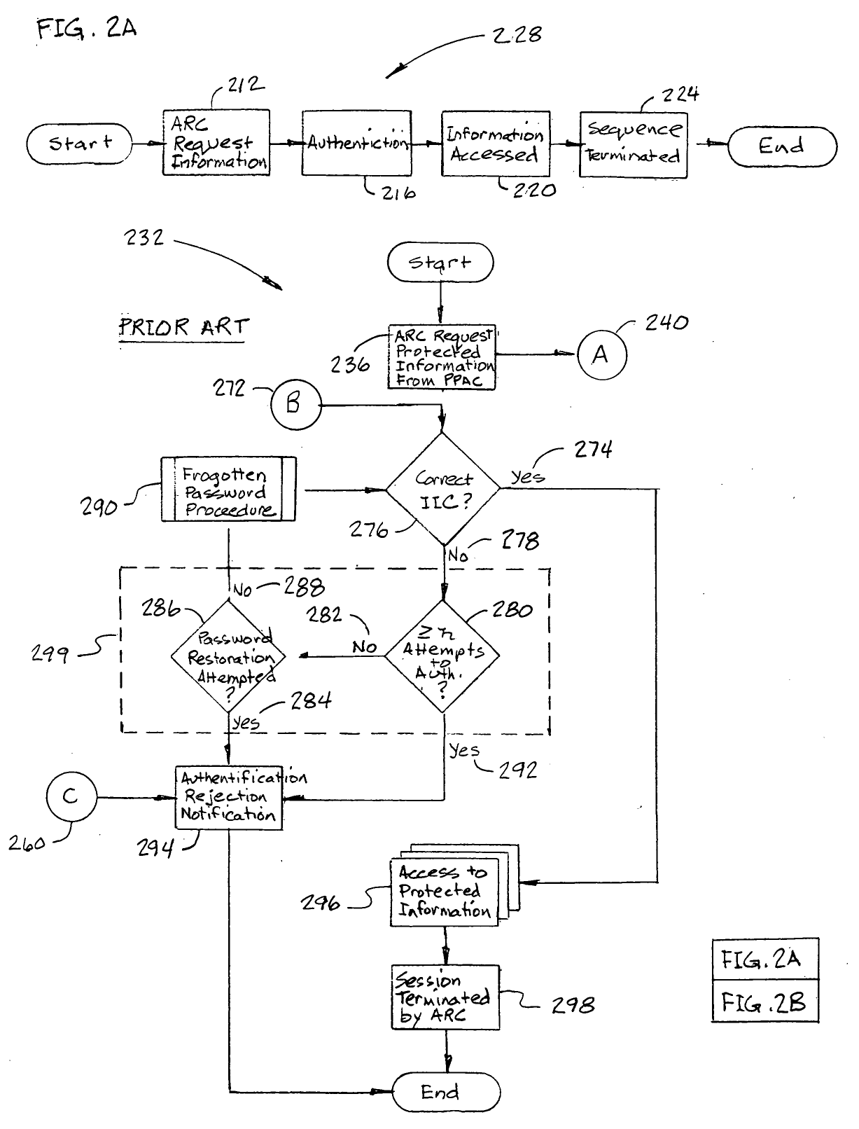

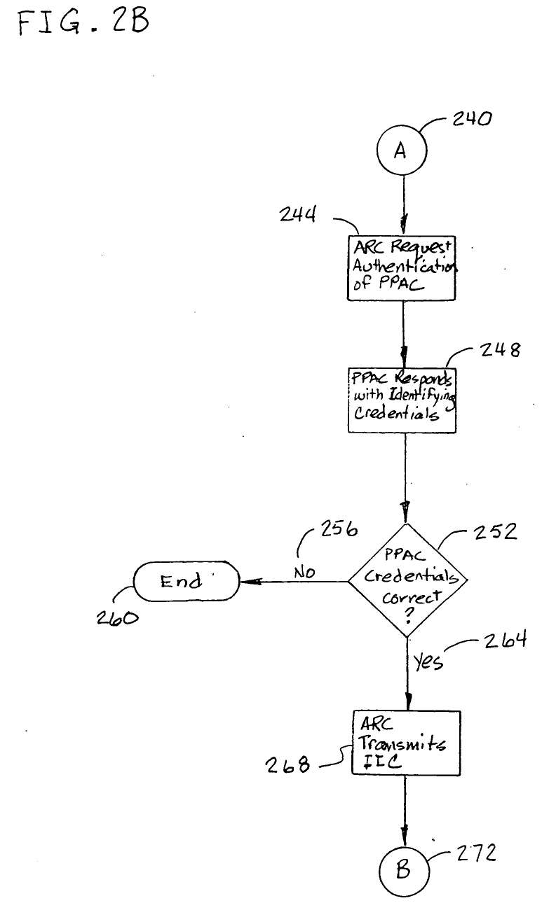

The preferred embodiment of the invention provides a method for improved authentication of a session to control access to protected information between an ARC and PPAC or between a user and a computer when the computer itself requires authentication of a user. In FIG. 1, ARC 112 possess means to request for protected information 116 from PPAC which includes but is not limited to the knowledge of a user name 120 and a shared secret 124 which when combined represents IIC or credential set and is used to facilitate identification protocol in communicating with PPAC authentication module 144.

Inputs

In FIG. 1, IIC or credential set which is represented by user name 120 and shared secret 124 is transmitted to PPAC authentication module 144 in combination with computer identity information to be known as CII, and computer configuration information hereafter known as CCI, collectively referred to as CII/CCI 132. Also transmitted with user name 120, shared secret 124, CII/CCI 132 are network descriptors factors 136, hereafter known as ND, and external factors 140, aforementioned as EI,
\tilde{x}={u,h(p),x_{CCI},x_{CII},x_{ND},x_{EI}} (1)
where x_{CCI}, x_{CII} is a set of information corresponding to ARC configuration, and x_{ND}, x_{EI} is a set of information corresponding to network location of the ARC and other elements obtained from non-ARC sources. Examples of elements of x_{CII} include, but are not limited to and or any combination of the following: MAC id, BIOS serial number, and other such computer identity information which may be obtained from the ARC or computer that is made available through means which can be discovered either electronically or with human intervention as could be interpreted and communicated to the PPAC or entity which controls the PPAC. Examples of elements of x_{CCI} include, but are not limited to and or any combination of the following: operating system version and serial number, software application(s) version and serial number, hard drive(s) serial number, hard drive disc space usage, random access memory size and other such computer information which may be obtained from the ARC or computer that is made available through means which can be discovered either electronically or with human intervention as could be interpreted and communicated to the PPAC or entity which controls the PPAC. Examples of elements of x_{ND} include, but are not limited to: network delay, network device identification information, geo-location information of network devices and ARC derived from network response time intervals, number of devices (HOPS) and types of devices between ARC and PPAC, ARC IP address and other such information which can be obtained and made available through means which can be discovered either electronically or with human intervention as could be interpreted and communicated to the PPAC or entity which controls the PPAC. Examples of environmental information elements of x_{EI} include but are not limited to: facts and events which shall include such sources from news that shall be local, regional and global; any industry indices, local, regional and global; measurable indicators of data traffic on all kinds of computer networks; financial information such as that relating to financial markets and money transfer activity, local, regional and global; government indicators and national security alters and indicators, also that of international security alters and indicators, internal security to the PPAC and, many other sources of external information and other such other information which can be obtained and made available through means which can be discovered either electronically or with human intervention as could be interpreted and communicated to the PPAC or entity which controls the PPAC.
Feature Extraction

In further aspects of FIG. 1, user name 120 and shared secret 124 are combined to form IIC. CII/CCI 132 and ND 136 and EI 140 together with IIC, collectively referred to as information set, are transmitted to feature extraction 148 as part of the PPAC authentication 144. Feature extraction function 148 receives the elements of the information set which then are mapped to a vector feature space in a process called feature extraction,
zₖⁿ=Φₖ(\tilde{x}ₖ)⊂R k=1, . . . , N (2)
where k is an index of information elements, n is an index of authentication attempts, Φₖ is an element-specific mapping, and N is the total number of elements in \tilde{x}. The details of Φ are system-specific, but it may be generally regarded as a distance function for user u between the presented element, \tilde{x}ₖ, and the target value for that user element, \tilde{x}*ₖ,
Φₖ(\tilde{x}ₖ)=d(\tilde{x}ₖ,\tilde{x}*ₖ) (3)

In this embodiment, we consider the following two variants,

$$\begin{matrix}{d}_{1} ( {\tilde{x}}_{k} , {\tilde{x}}_{k}^{*} ) = \{ \begin{matrix}1 , & {\tilde{x}}_{k} = {\tilde{x}}_{k} \\ 0 , & else\end{matrix} & ( 4 ) \\ {d}_{2} ( {\tilde{x}}_{k} , {\tilde{x}}_{k}^{*} ) = \frac{{\tilde{x}}_{k} - {μ}_{k}^{*}}{{σ}_{k}^{*}} & ( 5 )\end{matrix}$$

where μ*ₖ, σ*ₖ are the mean and standard deviations, respectively, of historical session values for successful logins obtained from 152. Note that (4) is suitable for unique identifiers such as passwords and serial numbers, while (5) is suitable for non-unique identifiers, such as network latency. Equations (4) and (5) can be extended or replaced in a variety of ways as discussed in the prior art {ref}. It is further stated that this limitation does not represent that this in the only means available to accomplishing this function in the preferred embodiment of the present invention.

As a final step in feature extraction, it may be necessary or desirable to apply additional transformations, e.g., rules, or other mappings, as commonly employed in prior art. It is further stated that this limitation does not represent that this in the only means available to accomplishing this function in the preferred embodiment of the present invention.

Outputs of 148 are also stored in 152 for future analysis.

Regression

The vector of features produced by 148, z*, is scored in 160 to give an indication of validity of authentication claim. In this embodiment we realize the scoring via regression using support vector machines (SVMs) (Boser et al., 1992; Vapnik, 1999).

Given a collection of the M most-recent historical values for features obtained from 152,
Z=[z^{n-M}, . . . ,zⁿ⁻¹]^{T} (6)
and corresponding target values of authentication confidence,
Y=[y^{n-M}, . . . ,yⁿ⁻¹] (7)
we seek to determine a map, ƒ:Z→Y. This process for support vector machines is readily described in the prior art (Scholkopf, 2002), given the specification of the appropriate model parameters. For this embodiment, we specify a radial basis function kernel. Model parameters {γ, ε} are selected based on leave-one-out cross-validation as described in (Chang & Lin, 2005).
Novelty Detection

It is well known in prior art regarding intrusion detection systems that novelty detection can be useful for authentication purposes. We incorporate this in the present embodiment in novelty detection 156 by using the one-class SVM algorithm (Schölkopf et al., 1999).

Definition 1 (Novelty Detection). Given a set of independent identically distributed (iid)) training samples, z¹, . . . ,z^{M}∈Z⊂R^{N}, drawn a probability distribution in feature space, P, the goal of novelty detection is to determine the “simplest” subset, S, of the feature space such that the probability that an unseen test point, z, drawn from P lies outside of S is bounded by an a priori specified value, υ∈(0,1].

In the one-class formulation, data in feature space is maximally separated from the origin using a hyperplane. The hyperplane parameters are determined by solving a quadratic programming problem, similar to the basic SVM case:

$$\begin{matrix}min ( \frac{1}{2} {‖ w ‖}^{2} + \frac{1}{vl} {\sum }_{i = 1}^{M} {ξ}_{i} - ρ ) \\ subject to & ( 8 ) \\ ( w \cdot {z}^{i} ) \geq ρ - {ξ}_{i} i = 1 , 2 , … , M {ξ}_{i} \geq 0 & ( 9 )\end{matrix}$$

where w and ρ are hyperplane parameters, ν is the asymptotic fraction of outliers (novelties) allowed, M is the number of training instances, and ξ is a slack variable. For solutions to this problem, w and ρ, the decision function
ƒ(\tilde{x})=sgn(w·z−p) (10)
specifies labels for examples, e.g., −1 for novelty.

Basic properties of the one-class SVM were proven in the initial paper (Scholkopf et al., 1999). The most important result is the interpretation of ν as both the asymptotic fraction of data labeled as outliers, and the fraction of support vectors returned by the algorithm. Implementation of the one-class SVM algorithm requires the following specifications: kernel function, kernel parameters, outlier fraction, and separating point in feature space. As with the basic SVM, there is no automatic method for specifying one-class SVM model parameters, but the interpretation of ν eases this task to some degree: the choice of outlier fraction should incorporate prior knowledge about the frequency of novelty occurrences (for example, a typical value for patient seizure frequency). Additionally, smaller values of ν increase the computational efficiency of the algorithm. The choice of origin as the separation point is arbitrary and affects the decision boundary returned by the algorithm. Other work (e.g., Hayton et al., 2001; Manevitz & Yousef, 2001) has addressed separation point selection given partial knowledge of outlier classes.

In the preferred embodiment of the invention, we select ν=0.01, radial basis function kernel, γ=1.0. These may also be learned via leave-one-out cross validation or other model selection techniques described in prior art.

Decision

The final decision to accept or reject a user is made in 168. This decision may be made based on classification. In the present embodiment we specify a simple rule
H=sgn(α·zⁿ+(1−α)·ƒ(\tilde{x}ⁿ)) (11)

Decision results of 168 are presented to 172. In one of two possible scenarios, decision results of 168 answer “no” 176 causing the session with ARC to be terminated 180. In the second scenario of two, decision results of 168 answer “yes” 184 permitting the ARC access to protected information 194.

What claimed is:

1. A computer possessing information in memory and or access to information through network means which consist of information of electronic data form that is readable through at least one computer and, said information is protected from access by human operators of same computer, and said information is protected from access by a second computer which is either operated by a human operator or operated through automated means of its own volition, which said access protected information is controlled through at least one computer.

2. What is claimed in claim 1, including means for at least one computer to grant permission to access protected information by human operators of same computer or by a second computer which is either operated by human operator or operated through automated means of its own volition.

3. What is claimed in claim 1, including means for at least one computer to determine the permissibility of at least one other computer to access protected information, whether computer itself possesses protected information and or the means to grant permission to said protected information, further possesses the means to determine there is at least one or more requests, whether sequential or simultaneous, to access protected information in which said requests originate from at least one or more computers operated by human operators of same computer(s) or by a second or more computer(s) which is either operated by human operator or operated through automated means of its own volition.

4. What is claimed in claim 3, including the permissibility request to grant access to said protected information, said request is created and or originated from at least one computer operated and or not operated by a human operator, which said same request includes certain identifying information which discloses the identify of the computer requesting access to protected information representing or not representing a human operator, which by invoking the action of permissibility to grant access to protected information said identifying information is discerned by said computer in a manner that at least in part assist in the analysis of said identity information for the purposes of granting access to protected information.

5. What is claimed in claim 4, whereby said analysis of identifying information may include a form of tangential information which directly or indirectly pertains to the computer requesting access to protected information and or the computer protecting access to protected information and or said tangential information can also be information which is acquired by any computer or computers associated in any of the aforementioned processes referenced in this claim and in all referenced claims, in part or in whole, and or is information that is not in any way whatsoever related to the said process but is deemed by any of the aforementioned processes referenced in this claim and in all referenced claims to be relevant, which said form of tangential information includes but is not limited to said information which is ascertained through electronic data means which is reported by said computer requesting access to protected information in response to electronic inquiry means which can be obtained through a specially formatted request in which said form of tangential information from said computer is created and or submitted as part of the request by instructing said requesting computer in advance of said request and or by formulating the desired content of said form of tangential information in an executable instructional code readable by and taught to said computer independent of said request and or by said form of tangential information transmitted by non-electronic means which is then incorporated into said request by human operator.

6. What is claimed in claim 5, including any information whether said requests for access to protected information, exchange of information between computers for the purpose of assessing permissibility and granting permission to said protected information, tangential information transmitted by any of the aforementioned means referenced in this claim and in all referenced claims, to also include any other information in any form desirous to transmit or impart, whether electronic form or other form, to and from all aforementioned computers referenced in this claim and in all referenced claims, shall include in some instances but not in all instances, at least one computer which is ancillary to the computer requesting access to protected information and or the computer possessing said protected information, whether ancillary computer is conjoined in the request or non-conjoined, said ancillary computer or computers shall be, when required, included in the aforementioned processes referenced in this claim and in all referenced claims capable or not capable of performing the same processes of any computer which has been referenced in this claim and all referenced claims thus far.

7. What is claimed in claim 6, which said form of tangential information included in said analysis of identifying information, whether in electronic form or not, further includes sources of such information from any other computer or computers, computer networks, information sources of any type, human knowledge or any other type of sources which may or may not be related either directly or indirectly to the computer requesting access to protected information and or the computer possessing protected information which includes the matter of granting permission to access protected information.

8. What is claimed in claim 7, whereby certain portions or all of information associated with granting access including all or part of information prior to and subsequent to granting access to protected information, including but not limited to said information which was acquired in the analysis used for granting permission to access protected information and any or all information which was ascertained and related or not related to granting said access to protected information including but not limited to tangential information, is collectively or partly recorded in at least said memory of at least one computer which may or may not be the computer possessing permissibility to protected information and or a memory medium which is not controlled by or may or may not require a computer to access such memory and or said any other means of recording said information which has not been referenced in this claim and in all referenced claims.

9. What is claimed in claim 8, all such information that is related and not related to the process of requesting and or granting permission and or providing access to protected information, in whatever means deem desirous, may be retained in said memory whether in part or totality, where such information may include but is not required to include further information resulting from the analysis of all information which is deemed by at least one computer possessing permissibility to grant access to protected information or any other computer related or not related to the process, where such information in part or totality is analyzed in a manner which shall be utilized to determine the permissibility of at least one incident of permission, and said same information may be conjoined with at least one other set of information relating to the process of granting permission to access protected information and, still more information may be conjoined to include all information in aggregate which has been referenced in this claim and all aforementioned referenced claims, whereby said aggregated information can continuously accumulate to increasingly substantiate its content to a greater degree of certainty in analyzing permissibility to access protected information, in part or in totality.

10. What is claimed in claim 9, whereby at least one authentication computer possessing in part or in whole, secret information which is protected among other non-secret information both which consist of information of electronic data form that is readable through at least one computer, which may or may not accessed through network means, and said computer may be accessed by human operator or operators of same computer, and or accessed by at least a second computer which is either operated by human operator or operated through automated means of its own volition, which said purpose for secret information is authentication of at least one computer and or at least one human and or at least one entity and or at least one other type of device which is capable of communication electronically with said authentication computer, which said authentication computer possesses means which compare said secret information possessed by and protected by the authentication computer with information which is proposed to be same information.
